(19) United States
(12) Patent Application Publication
(10) Pub. No.: US 2026/0065067 A1
(43) Pub. Date: Mar. 5, 2026

(54) METHOD FOR INVERSE CONSTRAINT LEARNING OF ELECTRONIC DEVICE, AND ELECTRONIC DEVICE USING INVERSE CONSTRAINT LEARNING

(71) Applicant: Korea Advanced Institute of Science and Technology, Daejeon (KR)

(72) Inventors: Daehyung PARK, Daejeon (KR); Jaehwi JANG, Daejeon (KR); Minjae SONG, Daejeon (KR)

(21) Appl. No.: 19/317,503

(22) Filed: Sep. 3, 2025

(30) Foreign Application Priority Data
Sep. 3, 2024 (KR) 10-2024-0119125

(51) Int. Cl. G06N 3/092

(52) U.S. Cl. CPC G06N 3/092

(57) ABSTRACT

An Inverse Constraint Learning method for an electronic device according to one aspect comprises acquiring demonstrations and task-reward candidates in a first learning environment of a neural network by the electronic device; estimating a total reward function that satisfies constraints, based on the demonstrations and the task-reward candidates; decomposing the total reward function into a transferable task reward function and a constraint reward function; and training the neural network to perform learning in a second learning environment, based on the constraint reward function.

### CROSS REFERENCE TO RELATED APPLICATION

The present application claims priority to Korean Patent Application No. 10-2024-0119125, filed Sep. 3, 2024, the entire contents of which are hereby incorporated by this reference in its entirety.

### BACKGROUND OF THE INVENTION

### Field of the Invention

The present invention relates to neural network learning of an electronic device, and more particularly, to Inverse Constraint Learning for learning constraints from given demonstration data.

This work was supported by Institute of Information & communications Technology Planning & Evaluation (IITP) grant funded by the Korea government (Ministry of Science and ICT) (Project unique No.: 2710080907; Project No.: RS-2022-II220311; R&D project: Development of core technologies for human-centered artificial intelligence; Research Project Title: Development of goal-directed reinforcement learning techniques for multi-contact robotic manipulation of everyday objects; and Project period: 2022 Apr. 1.˜2026 Dec. 31.), Korea Advanced Institute of Science and Technology grant funded by the Korea government (Ministry of Science and ICT) (Project No.: N10250047; R&D project: Operation of a large-scale convergence research institute; Research Project Title: Ultra-fast development of autonomous vehicles driven by robot experience design; and Project period: 2023 May 1.˜2025 Dec. 31.), and Artificial Intelligence Industry Convergence Cluster Agency grant funded by the Korea government (Ministry of Science and ICT) and Gwangju Metropolitan City (R&D project: AI-centered industrial convergence complex development project; Research Project Title: Development of a humanoid foundation model capable of human-like communication, imagination, and learning; and Project period: 2025 Apr. 1.˜2025 Dec. 31.).

### Description of the Related Art

Constraints are used to learn safe and efficient skills in real life. Constraints are conditions identified separately from existing task rewards and specify conditions that an agent must always adhere to. For example, in a pathfinding task where the goal is to reach a destination as quickly as possible, if a maximum speed limit constraint is specified, the agent needs to find a policy that reaches the destination the fastest without exceeding the maximum speed.

In the learning process using such constraints, various methods are being discussed to find constraints that are usable in a new actual environment, but they are limited to methodologies that uniquely learn constraints by requiring only precise information about the task reward.

The background technology described above is technical information that the inventor possessed for the derivation of the present invention or acquired during the process of deriving the present invention, and is not necessarily publicly known technology disclosed to the general public before the filing of the present invention.

### SUMMARY OF THE INVENTION

In an embodiment of the present invention, an Inverse Constraint Learning technique is proposed that can efficiently learn transferable constraints in a new learning environment by estimating a reward function that satisfies the constraints using task-reward candidates as training data, instead of using precise information about the task reward.

The problems to be solved by the present invention are not limited to those mentioned above, and other unmentioned problems to be solved will be clearly understood by those of ordinary skill in the art to which the present invention pertains from the following descriptions.

An Inverse Constraint Learning method for an electronic device according to one aspect of the present invention may provide a method comprising: acquiring demonstrations and task-reward candidates in a first learning environment of a neural network by the electronic device; estimating a total reward function that satisfies the constraints, based on the demonstrations and the task-reward candidates; decomposing the total reward function into a transferable task reward function and a constraint reward function; and training the neural network in a second learning environment, based on the constraint reward function.

Here, the estimating may include performing inverse reinforcement learning.

Furthermore, the decomposing may include outputting the transferable task reward function such that the action difference between the task policy of the first learning environment and the demonstrations is minimized.

Furthermore, the decomposing may include identifying the constraint reward function as the reward function remaining after excluding the transferable task reward function from the total reward function.

An electronic device according to another aspect of the present invention comprises: an acquisition unit (110) for acquiring demonstrations and task-reward candidates in a first learning environment; a storage unit (120) including instructions for outputting a constraint reward function based on the demonstrations and the task-reward candidates, using a pre-trained neural network; and a processing unit (130) for controlling the neural network to output a learning result in a second learning environment based on the constraint reward function by executing the instructions.

Here, the neural network may include: an inverse reinforcement learning unit (124) for estimating a total reward function that satisfies the constraints, based on the demonstrations and the task-reward candidates; and a reward decomposition unit (126) for decomposing the total reward function into the transferable task reward function and the constraint reward function.

Furthermore, the reward decomposition unit may output the transferable task reward function such that the action difference between the task policy of the first learning environment and the demonstrations is minimized.

Furthermore, the reward decomposition unit may identify the constraint reward function as the reward function remaining after excluding the transferable task reward function from the total reward function.

A non-transitory computer-readable recording medium according to another aspect of the present invention stores a computer program, wherein the computer program includes instructions for causing a processor to perform an Inverse Constraint Learning method for an electronic device, and the method comprises: acquiring demonstrations and task-reward candidates in a first learning environment of a neural network by the electronic device; estimating a total reward function that satisfies the constraints, based on the demonstrations and the task-reward candidates; decomposing the total reward function into a transferable task reward function and a constraint reward function; and training the neural network to perform learning in a second learning environment, based on the constraint reward function.

A computer program stored on a non-transitory computer-readable recording medium according to another aspect of the present invention, wherein the computer program includes instructions for causing a processor to perform an Inverse Constraint Learning method for an electronic device, and the method comprises: acquiring demonstrations and task-reward candidates in a first learning environment of a neural network by the electronic device; estimating a total reward function that satisfies the constraints, based on the demonstrations and the task-reward candidates; decomposing the total reward function into a transferable task reward function and a constraint reward function; and training the neural network to perform learning in a second learning environment, based on the constraint reward function.

According to an embodiment of the present invention, constraints are learned using constrained demonstrations and task-reward candidates, and these constraints are implemented to be usable in other learning environments. Through this, the present invention was able to confirm higher transferability than other state-of-the-art Inverse Constraint Learning methods through simulation experiments, and also confirmed that transferable constraints can be learned through experiments using a real robot.

### BRIEF DESCRIPTION OF THE DRAWINGS

FIG. 1 is a block diagram for illustratively explaining the function of an electronic device using Inverse Constraint Learning according to an embodiment of the present invention.

FIG. 2 is a block diagram for specifically explaining the function of the neural network in the storage unit in the electronic device using Inverse Constraint Learning of FIG. 1.

FIG. 3 is a flowchart for illustratively explaining an Inverse Constraint Learning method of an electronic device according to an embodiment of the present invention.

### DETAILED DESCRIPTION OF THE INVENTION

The advantages and features of the present invention, and the methods for achieving them, will become clear by referring to the embodiments described in detail below with reference to the accompanying drawings. However, the present invention is not limited to the embodiments disclosed below and can be implemented in various forms. These embodiments are provided only to make the disclosure of the present invention complete and to fully inform those of ordinary skill in the art to which the present invention pertains of the scope of the invention, and the scope of the present invention is defined only by the claims.

In describing the embodiments of the present invention, detailed descriptions of known functions or configurations will be omitted except when actually necessary for explaining the embodiments of the present invention. The terms described below are defined in consideration of their functions in the embodiments of the present invention and may vary according to the intention or custom of the user or operator. Therefore, their definitions should be made based on the content throughout this specification.

Constraints are used to learn safe and efficient skills in real life. Constraints are conditions identified separately from existing task rewards and specify conditions that an agent must always adhere to. For example, in a pathfinding task where the goal is to reach a destination as quickly as possible, if a maximum speed limit constraint is specified, the agent needs to find a policy that reaches the destination the fastest without exceeding the maximum speed.

Furthermore, Inverse Constraint Learning refers to the process of learning constraints from given demonstrations, and the transferability of the constraints is used as a measure to determine the performance of the constraints learned through inverse constraint learning. Through constraint transferability, it is possible to verify whether the constraints are properly transferred to other tasks or other environments, like real constraints.

Inverse Constraint Learning is an “ill-posed” problem where multiple solutions can exist. This is because different combinations of task rewards and constraints can produce the same demonstration result. To find usable constraints for a new environment from among all possible combinations of task rewards and constraints, conventional Inverse Constraint Learning methods use prior knowledge.

Prior knowledge, for example, assumes discretized state and action spaces, limits the form of constraints (parametrized constraints), or requires a task-reward specification. The most recent constraint learning methods are limited to uniquely learning constraints by requiring only the task-reward specification.

In an embodiment of the present invention, a method is presented that requires task-reward candidates instead of a task-reward specification, proposing an Inverse Constraint Learning technique that learns constraints usable in a new learning environment.

Hereinafter, embodiments of the present invention will be described in detail with reference to the accompanying drawings.

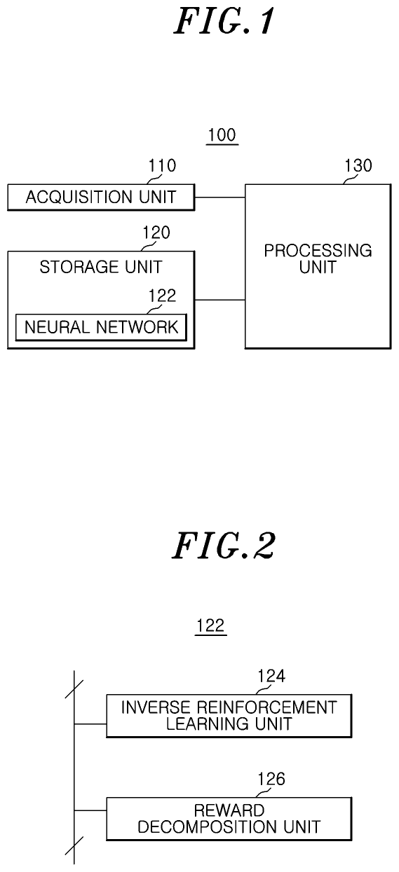

FIG. 1 is a block diagram for illustratively explaining the function of an electronic device (100) using Inverse Constraint Learning according to an embodiment of the present invention.

The electronic device (100) is a means for performing Inverse Constraint Learning according to an embodiment of the present invention. In an embodiment of the present invention, the electronic device (100) may include at least one of, for example, a smartphone, a tablet personal computer, an e-book reader, a laptop personal computer, a netbook computer, and a wearable device (e.g., a smart watch, smart glasses, a head-mounted-device (HMD), a smart ring, an electronic bracelet, an electronic necklace, a smart mirror, etc.). In another embodiment, the electronic device (100) may include at least one of a network security device, a navigation device, marine electronic equipment (e.g., marine navigation equipment, a gyro compass, etc.), avionics, a vehicle head unit, a point of sales (POS) in a store, and an internet of things device. Furthermore, the electronic device (100) may be equipped with an application for executing various operations for Inverse Constraint Learning (data computation, screen display, information input/output operations, etc.). The application may include, for example, a smartphone application, a personal computer (PC) application, a set-top box (STB) application, a web application, an instant application, etc., and need not be limited to a specific application.

As shown in FIG. 1, the electronic device (100) may include an acquisition unit (110), a storage unit (120), and a processing unit (130).

The acquisition unit (110) may acquire demonstrations and task-reward candidates in a first learning environment. The acquisition unit (110) may include, for example, a communication device connected via a network, a user interface (UI) device for inputting training data, etc. The communication device may include, for example, a short-range communication device such as WiFi, Bluetooth, or ultra-wide band (UWB), and a wide-area communication device such as the internet or a mobile communication network.

The storage unit (120) may include instructions for outputting a constrained reward function based on the demonstrations and the task-reward candidates using a pre-trained neural network (122). Any instructions within the storage unit (120) may be stored in the form of an application, program, etc., and any stored instruction may be selected and executed by the processing unit (130). The storage unit (120) may include, for example, memory such as random access memory (RAM) or read only memory (ROM), and a recording medium such as a local disk or storage connected via a network, and need not be limited to a specific recording medium in implementing the embodiments of the present invention.

The processing unit (130) may control the neural network to output a learning result in a second learning environment based on the constraint reward function by executing the instructions of the storage unit (120). The processing unit (130) may include, for example, a microprocessor-based processing device.

To this end, the neural network (122) in the storage unit (120) may include a pre-trained neural network configured to acquire the demonstrations and the task-reward candidates in the first learning environment, estimate a total reward function that satisfies the constraints based on the demonstrations and the task-reward candidates, and decompose the total reward function into a transferable task reward function and a constraint reward function.

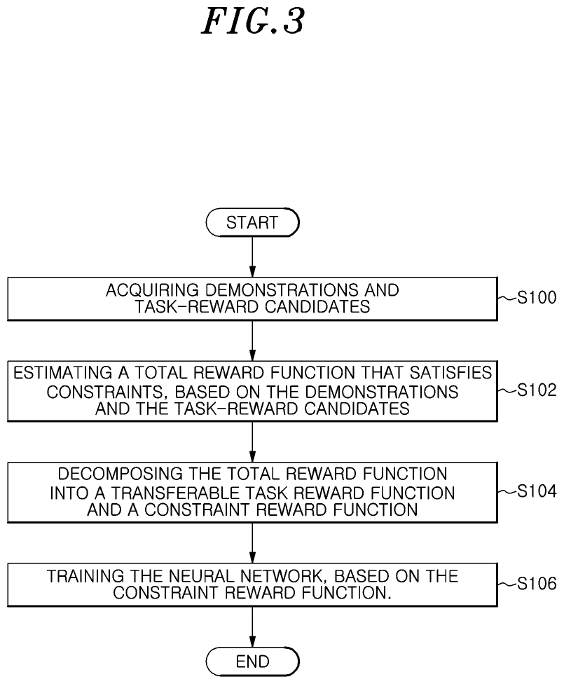

FIG. 2 is a block diagram for specifically explaining the function of the neural network (122) in the storage unit (120) in the electronic device (100) using Inverse Constraint Learning of FIG. 1.

As shown in FIG. 2, the neural network (122) may include an inverse reinforcement learning unit (124) and a reward decomposition unit (126).

The inverse reinforcement learning unit (124) may perform inverse reinforcement learning to estimate a total reward function that satisfies the constraints, based on the demonstrations and the task-reward candidates. Inverse reinforcement learning may apply a technique that finds the total reward function using a known inverse reinforcement learning module, and since this may be easily understood by those of ordinary skill in the technical field of the present invention, a detailed description of the learning process will be omitted.

The reward decomposition unit (126) may decompose the total reward function estimated by the inverse reinforcement learning unit (124) into a transferable task reward function and a constraint reward function. At this time, the reward decomposition unit (126) may output the transferable task reward function such that the action difference between the task policy of the first learning environment and the demonstrations is minimized. Furthermore, the reward decomposition unit (126) may identify the constraint reward function as the reward function remaining after excluding the transferable task reward function from the total reward function.

Hereinafter, the Inverse Constraint Learning process according to an embodiment of the present invention will be described in detail with reference to the flowchart of FIG. 3, along with the configuration described above.

FIG. 3 is a flowchart for illustratively explaining an Inverse Constraint Learning method of the electronic device (100) according to an embodiment of the present invention.

As shown in FIG. 3, the electronic device (100) may acquire demonstrations and task-reward candidates in a first learning environment of the neural network (122) (S100). A first learning environment may include an environment in which the electronic device (100) initially trains the neural network (122). Here, the first learning environment may be, for example, a learning environment for reaching destination A via an optimal route when the electronic device (100) is a navigation device. The demonstrations may include data acquired as examples of performing a given task, which are used as a basis for training the neural network (122). For example, demonstrations may include trajectories or actions recorded when a user or electronic device (100) performs a task such as driving to a specific destination. The task-reward candidates may include a set of possible reward functions related to the task to be performed. These candidates, together with the demonstrations, may be used to estimate a total reward function (R).

Subsequently, the electronic device (100) may estimate a total reward function (R) that satisfies the constraints, based on the demonstrations and the task-reward candidates acquired in step (S100) (S102). The total reward function (R) may include an overall reward function estimated based on the demonstrations and the task-reward candidates, which satisfies given constraints and reflects both task objectives and constraint conditions. For example, the electronic device (100) may estimate the total reward function (R) for reaching destination A via the optimal route using an inverse reinforcement learning method.

Subsequently, the electronic device (100) may decompose the total reward function (R) estimated in step (S102) into a transferable task reward function (R′) and a constraint reward function (Rc) (S104). The transferable task reward function may include a task reward function derived from the total reward function that can be transferred to and applied in a new learning environment. For example, a transferable task reward function may correspond to a reward for reaching a destination along an optimal route, which remains applicable even when the destination changes. The constraint reward function may include a reward function derived from the total reward function that corresponds to environmental or regulatory constraints. The constraint reward function (Rc) may include, for example, a reward function for adhering to a specified speed limit while reaching destination A via the optimal route.

Here, the decomposing (S104) may include outputting the transferable task reward function (R′) such that the action difference between the task policy of the first learning environment and the demonstrations is minimized, and identifying the constraint reward function (Rc) as the reward function remaining after excluding the transferable task reward function (R′) from the total reward function (R).

Subsequently, the electronic device (100) may train the neural network (122) in a second learning environment based on the constraint reward function (Rc) decomposed in step (S104) (S106). The second learning environment may include an environment in which the electronic device (100) trains the neural network (122) under conditions corresponding to a destination of navigation device, different from those of the first learning environment. The second learning environment may be, for example, a learning environment for reaching a destination B, which is different from destination A of the first learning environment, via an optimal route.

According to the embodiments of the present invention as described above, constraints are learned using constrained demonstrations and task-reward candidates, and these constraints are implemented to be usable in other learning environments. Through this, the present invention was able to confirm higher transferability than other state-of-the-art Inverse Constraint Learning methods through simulation experiments, and also confirmed that transferable constraints may be learned through experiments using a real robot.

Meanwhile, the combinations of each block in the attached block diagrams and each step of the flowcharts may also be performed by computer program instructions. These computer program instructions may be loaded into a processor of a general-purpose computer, a special-purpose computer, or other programmable data processing equipment, so that the instructions executed by the processor of the computer or other programmable data processing equipment create means for performing the functions described in each block of the block diagram.

These computer program instructions can also be stored in a computer-usable or non-transitory computer-readable recording medium (or memory) that can direct a computer or other programmable data processing equipment to function in a particular manner, so that the instructions stored in the computer-usable or non-transitory computer-readable recording medium (or memory) can also produce an article of manufacture containing instruction means that perform the functions described in each block of the block diagram.

Furthermore, the computer program instructions can also be loaded onto a computer or other programmable data processing equipment, so that a series of operational steps are performed on the computer or other programmable data processing equipment to create a computer-implemented process, and the instructions that execute the computer or other programmable data processing equipment can also provide steps for executing the functions described in each block of the block diagram.

In addition, each block may represent a module, segment, or part of a code that includes at least one or more executable instructions for executing the specified logical function(s). It should also be noted that in some alternative implementations, the functions mentioned in the blocks may occur out of order. For example, two blocks shown in succession may in fact be executed substantially concurrently or the blocks may sometimes be executed in reverse order, depending on the corresponding function.

What is claimed is:

1. An Inverse Constraint Learning method for an electronic device, comprising:
acquiring demonstrations and task-reward candidates in a first learning environment of a neural network by the electronic device;
estimating a total reward function that satisfies constraints, based on the demonstrations and the task-reward candidates;
decomposing the total reward function into a transferable task reward function and a constraint reward function; and
training the neural network in a second learning environment, based on the constraint reward function.

2. The method of claim 1, wherein the estimating includes:
performing inverse reinforcement learning.

3. The method of claim 1, wherein the decomposing includes:
outputting the transferable task reward function such that an action difference between a task policy of the first learning environment and the demonstrations is minimized.

4. The method of claim 3, wherein the decomposing includes:
identifying the constraint reward function as a reward function remaining after excluding the transferable task reward function from the total reward function.

5. The method of claim 1, wherein the electronic device includes a navigation device,
wherein the first learning environment may include an initial destination where the electronic device initially trains the neural network, and
wherein the second learning environment may include a subsequent destination different from the initial destination.

6. The method of claim 1, wherein the demonstrations include training data for the neural network obtained as examples of performing a predetermined task,
wherein the task-reward candidates include a set of reward functions corresponding to the predetermined task, and
wherein the total reward function includes an overall reward function estimated based on the demonstrations and the task-reward candidates, which satisfies the constraints and task objectives for the predetermined task.

7. The method of claim 1, wherein the transferable task reward function includes a task reward function that is capable of being transferred to and applied in the second learning environment, and
wherein the constraint reward function includes a reward function corresponding to a constraint for the second learning environment.

8. An electronic device, comprising:
an acquisition unit for acquiring demonstrations and task-reward candidates in a first learning environment;
a storage unit including instructions for outputting a constraint reward function based on the demonstrations and the task-reward candidates, using a pre-trained neural network; and
a processing unit for controlling the neural network to output a learning result in a second learning environment based on the constraint reward function by executing the instructions.

9. The device of claim 8, wherein the neural network includes:
an inverse reinforcement learning unit for estimating a total reward function that satisfies constraints, based on the demonstrations and the task-reward candidates; and
a reward decomposition unit for decomposing the total reward function into a transferable task reward function and the constraint reward function.

10. The device of claim 8, wherein the reward decomposition unit outputs the transferable task reward function such that an action difference between a task policy of the first learning environment and the demonstrations is minimized.

11. The device of claim 10, wherein the reward decomposition unit identifies the constraint reward function as a reward function remaining after excluding the transferable task reward function from the total reward function.

12. The device of claim 8, wherein the electronic device includes a navigation device,
wherein the first learning environment may include an initial destination where the electronic device initially trains the neural network, and
wherein the second learning environment may include a subsequent destination different from the initial destination.

13. The device of claim 8, wherein the demonstrations include training data for the neural network obtained as examples of performing a predetermined task,
wherein the task-reward candidates include a set of reward functions corresponding to the predetermined task, and
wherein the total reward function includes an overall reward function estimated based on the demonstrations and the task-reward candidates, which satisfies the constraints and task objectives for the predetermined task.

14. The device of claim 8, wherein the transferable task reward function includes a task reward function that is capable of being transferred to and applied in the second learning environment, and
wherein the constraint reward function includes a reward function corresponding to a constraint for the second learning environment.

15. A non-transitory computer-readable storage medium storing a computer program, wherein the computer program comprises instructions for causing a processor to perform an Inverse Constraint Learning method of an electronic device, and wherein the method comprises:
acquiring demonstrations and task-reward candidates in a first learning environment of a neural network by the electronic device;
estimating a total reward function that satisfies constraints, based on the demonstrations and the task-reward candidates;
decomposing the total reward function into a transferable task reward function and a constraint reward function; and
training the neural network to perform learning in a second learning environment, based on the constraint reward function.

16. The non-transitory computer-readable storage medium of claim 15, wherein the estimating includes:
performing inverse reinforcement learning.

17. The non-transitory computer-readable storage medium of claim 15, wherein the decomposing includes:
outputting the transferable task reward function such that an action difference between a task policy of the first learning environment and the demonstrations is minimized.

18. The non-transitory computer-readable storage medium of claim 15, wherein the decomposing includes:
identifying the constraint reward function as a reward function remaining after excluding the transferable task reward function from the total reward function.

19. The non-transitory computer-readable storage medium of claim 15, wherein the electronic device includes a navigation device,
wherein the first learning environment may include an initial destination where the electronic device initially trains the neural network, and
wherein the second learning environment may include a subsequent destination different from the initial destination.

20. The non-transitory computer-readable storage medium of claim 15, wherein the demonstrations include training data for the neural network obtained as examples of performing a predetermined task,
wherein the task-reward candidates include a set of reward functions corresponding to the predetermined task, and
wherein the total reward function includes an overall reward function estimated based on the demonstrations and the task-reward candidates, which satisfies the constraints and task objectives for the predetermined task.
